(19) United States
(12) Patent Application Publication
(10) Pub. No.: US 2010/0250873 A1
(43) Pub. Date: Sep. 30, 2010

(54) MANAGEMENT APPARATUS FOR MANAGING STORAGE APPARATUS

(75) Inventors: Keiko Fujii, Kato (JP); Noriaki Matsuzaki, Kato (JP); Akinori Tanizawa, Kato (JP); Hideaki Hasegawa, Kato (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/700,782

(22) Filed: Feb. 5, 2010

(30) Foreign Application Priority Data
Mar. 31, 2009 (JP) 2009-87730

(51) Int. Cl. G06F 12/00; G06F 12/08

(52) U.S. Cl. 711/154; 711/170; 711/E12.001; 711/E12.016

(57) ABSTRACT

A management includes an acquiring unit for acquiring information of specifying a target virtual storage in a target storage pool and an expansion storage capacity to be acquired from another storage pool other than the target storage pool, and a determining unit for determining the real storage to be used for the expansion storage capacity of the target virtual storage from candidate one of the real storages in the another storage pool, which are under the control of the controller in charge of the real storage that the target virtual storage is defined, on the basis of an occupied storage capacity defined as the virtual storage on the real storage in the another storage pool and a free storage capacity of the real storage in the another storage pool.

### CROSS-REFERENCE TO RELATED APPLICATIONS

This application is based upon and claims the benefit of priority of the prior Japanese Patent Application No. 2009-87730, filed on Mar. 31, 2009, the entire contents of which are incorporated herein by reference.

### FIELD

The embodiments discussed herein are related to management apparatus, which manage a storage apparatus having a plurality of storages such as magnetic disks responsible for storing information and designed to be accessed by a plurality of users.

### BACKGROUND

Heretofore, a storage system that allows a plurality of users to access a storage apparatus having a plurality of storages such as magnetic disks responsible for storing information has been known in the art.

The storage system assigns the plurality of storages in the storage apparatus to the respective users to provide each user with a group of storages called a storage pool. Therefore, each user can access the storages in the storage pool assigned to the user. In the original assignment, storage capacity to be used by each user is predicted and the storage is then assigned to each user based on the prediction. However, there is a case that a situation will be changed while using and the storage capacity of the storage pool for a certain user (here, referred to as a first user) may become insufficient. In that case, an additional storage may be installed to the storage pool for the user. However, the installation of the additional storage is not always an efficient usage of the entire storage capacity when there is a less-frequently-used storage in the storage pool for another user (herein referred to as a second user). Even if there is the less-frequently-used storage in the storage pool for the second user, such the storage is actually used and is not an unused storage. Because of other limitations, the first user cannot be allowed to directly use the storage.

Here, there is a proposal that a pool's free space common to a plurality of groups that correspond to the above respective storage pools is prepared in advance and the space area is assigned to the group of poor space. However, the preparation of such a space area for the pool prevents an efficient use of the storage capacity by just that much.

In addition, it is proposed to move the allotment of storage for specific genre data from a certain storage subsystem to another storage subsystem depending on the usage condition of each storage subsystem in an environment marked by a mixture of a plurality of storage subsystems with different processing abilities. However, this proposal is no good for the system in which available pools are assigned to the respective users.

Another system, which has been proposed, is one that borrows or rents the storage capacity of a remote place when data is stored in the remote place via a network or a communication line. However, such a proposed system is also independent of making an efficient use of the storage capacity in the system in which a plurality of storage pools are installed in a single storage apparatus.

Japanese Laid-Open Patent Publication No. 2007-193573, Japanese Laid-Open Patent Publication No. 2005-276017, Japanese Laid-Open Patent Publication No. 2004-265173, and Japanese Laid-Open Patent Publication No. 2002-92517 are examples of related art.

### SUMMARY

According to an aspect of the invention, a management apparatus for managing a plurality of storage pools having a plurality of real storages grouped at each user and a virtual storage logically defined on the real storage in a storage apparatus, the storage apparatus having the plurality of real storages for existing physically and a plurality of controllers for individually controlling access to the respective real storages. The management includes an acquiring unit for acquiring information of specifying a target virtual storage in a target storage pool and an expansion storage capacity to be acquired from another storage pool other than the target storage pool, and a determining unit for determining the real storage to be used for the expansion storage capacity of the target virtual storage from candidate one of the real storages in the another storage pool, which are under the control of the controller in charge of the real storage that the target virtual storage is defined, on the basis of an occupied storage capacity defined as the virtual storage on the real storage in the another storage pool and a free storage capacity of the real storage in the another storage pool.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a storage pool;

FIG. 2 is a schematic diagram of the entire configuration of a storage system;

FIG. 3 is a diagram illustrating a first example of an operation screen displayed on an operations management server;

FIG. 4 is a diagram illustrating a first example of a storage pool;

FIG. 5 is a flow chart illustrating a process to be carried out when an “end” button is pressed on the screen illustrated in FIG. 3;

FIG. 6 is a diagram illustrating a second example of an operation screen displayed on an operations management server;

FIG. 7 is a diagram illustrating a second example of a storage pool;

FIG. 8 is a flow chart illustrating a process to be carried out when a “selection” button is pressed on the screen illustrated in FIG. 6; and

FIG. 9 is a flow chart illustrating a process to be carried out in an operations management server in stead of the process illustrated by the flow chart illustrated in FIG. 8.

### DESCRIPTION OF EMBODIMENTS

Hereinafter, an embodiment will be described.

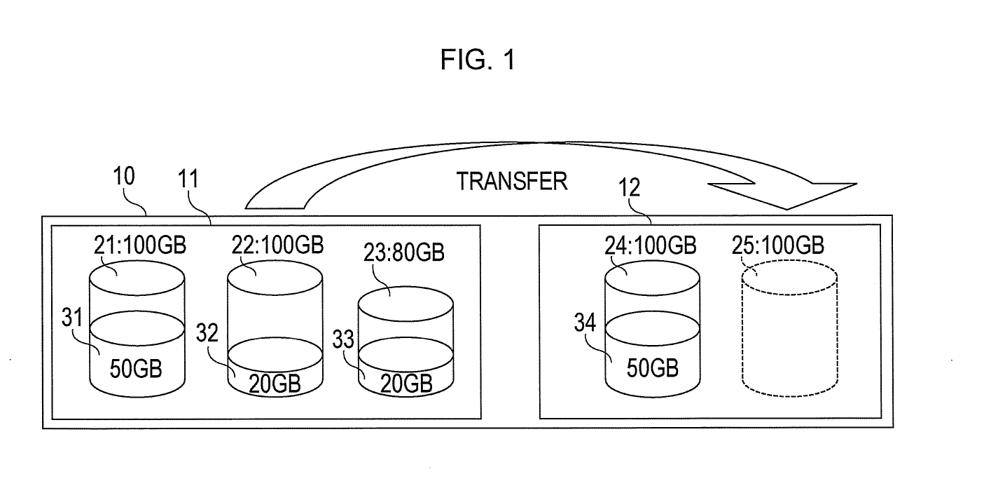

FIG. 1 is a schematic diagram illustrating a storage pool.

A storage apparatus 10 illustrated in the figure includes four real disks 21 to 24 which are physically existing storage media. The storage capacities of the real disks 21 to 24 are 100 GB, 100 GB, 80 GB, and 100 GB, respectively. The real disk 25 represented by the dashed line in the figure will be separately described later. Among the four real disks 21 to 24, three real disks 21 to 23 constitute one storage pool 11 which can be used by user A. Among them, furthermore, the real disk 24 constitutes one storage pool 12 by itself, which can be used by another user B.

In addition, virtual disks 31 to 34 are logically built in the real disks 21 to 24, respectively. The virtual disks 31 to 34 are logically built beyond the physical bounds of real disks to be made available for the user. In FIG. 1, the virtual disks 31 to 34 are built for the respective real disks 21 to 24 one by one. Alternatively, one virtual disk may be built for two or more real disks or two or more virtual disk may be formed for one real disk.

However, any virtual disk cannot be defined for extending over a plurality of storage pools. In addition, even in a single storage pool, any virtual disk cannot be defined for extending over a plurality of real disks with different control modules (CM) in charge as described later.

The user A can access the storage pool 11 assigned to the user A, and the user B can access the storage pool 12 assigned to the user B. In the access, any virtual disk can be designated without concerning the configuration of each of the real disks 21 to 23 and 24 of the respective storage pools 11 and 12, and any address in the virtual disk can be then designated to execute the access. The storage apparatus 10 converts the designated virtual disk and the address therein into the corresponding real disk and the address therein to access the real disk. In other words, when the access is to record data, the data transmitted from the user is recorded on the address in the real disk. In contrast, when the access is to read the data, the data is read from the address in the real disk and then transmitted to the user.

A component responsible for control of the access is called a control module (CM). In the case of the storage apparatus 10 illustrated in FIG. 1, there are two CMs, CM0 and CM1. The real disks 21 to 24 are provided with the designated CMs in charge of the control of access to the real disks 21 to 24, respectively. Here, each of the CMs in charge of the respective real disks 21 to 24 is referred to as a “CM in charge”. The CMs assigned to four real disks 21 to 24 illustrated in FIG. 1 are CM0, CM1, CM0, and CM1, respectively. If the same CM takes care of different real disks in one storage pool, then one virtual disk can be defined as one extending over two or more real disks.

Here, consideration will be given to the addition of storage capacity when the storage capacity of the storage pool 12 used by the user B becomes insufficient. An example illustrated in FIG. 1, the virtual disk 34 with a capacity of 50 GB is defined in the real disk 24 with a storage capacity of 100 GB. Therefore, even if the storage pool 12 is not provided with an additional real disk, the storage capacity of the virtual disk 34 can be increased up to 100 GB, the storage capacity of the real disk 24. In the real disk 24, another virtual disk with a storage capacity of up to 50 GB may be defined in addition to the virtual disk 34. However, if it exceeds such an allowable capacity of 50 GB, for example in the case of requiring an additional storage capacity of 100 GB, then there is a need of installing a new real disk 25 in the storage apparatus 10. The new real disk 25 may be installed in the storage apparatus 10 where such a new real disk 25 has not been placed. Alternatively, however, any real disk which can be transferred to the storage pool 12 may be searched in another storage pool (here, for example, the storage pool 11) instead of the addition of the new real disk 25. If the storage pool 11 includes any real disk which can be transferred to the storage pool 12, then such a real disk may be transferred to the storage pool 12 to eliminate the need for addition of the new real disk 25. As a result, efficiency in usage of storage capacity can be increased. The transfer of the real disk from one storage pool to another only requires a change in definition of storage pools. Thus, it is also advantageous in cost.

In the embodiment described herein, a real disk to be transferred is determined by investigating whether it satisfies various conditions listed below.

(a) In the case of building a virtual disk over both the existing real disk and the transferred real disk in a storage pool where the real disk has been transferred, the transferred real disk should be one having the same CM in charge as that of the existing real disk.
(b) In the case of newly building a virtual disk in the transferred real disk in a storage pool where the real disk has been transferred, the efficiency of access can be increased when the real disks in one storage pool are independently assigned to the respective CMs in charge.
(c) In a storage pool from which a real disk is transferred, a virtual disk built in the real disk to be transferred can be only transferred to the real disk of which the same CM as one in change of the real disk to be transferred takes charge, which is in the storage pool from which the real disk is transferred.

Therefore, in order to empty the real disk to be transferred, a real disk of which the same CM as one in charge of the real disk should be present in the storage pool where such a real disk belongs, and also the free space of the real disk on which the same CM in charge should be not less than the usage of a virtual disk to be built in the real disk to be transferred. However, in the storage pool to which the real disk to be transferred belongs, if there are two or more other real disks under the control of the same CM as one in charge of the real disk to be transferred in addition to the real disk to be transferred, the total of the free spaces of two or more real disks may be not less than the usage of the virtual disk in the real disk to be transferred. In that case, the virtual disk can be built while being distributed over two or more real disks.

Therefore, the real disk can be transferred and the utilization efficiency of its storage capacity can be enhanced if it satisfies the above conditions.

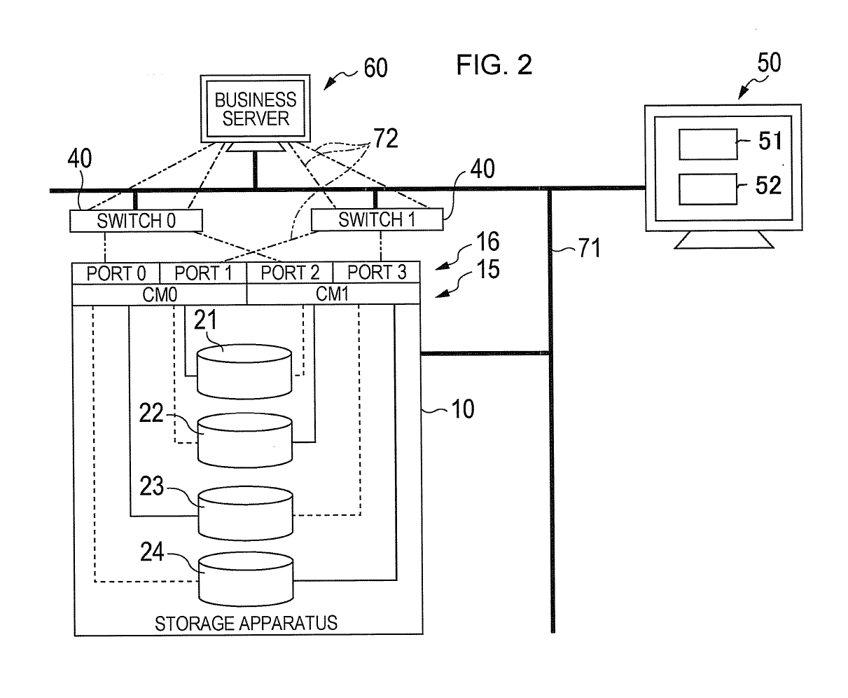

FIG. 2 is a schematic diagram of the entire configuration of a storage system. The figure illustrates the storage apparatus 10 which is also illustrated in FIG. 1, switches 40 (an example of a conversion apparatus in claims), an operations management server 50 (an example of a management apparatus in claims), and a business server 60 (an example of a user device in claims). In addition, the figure also illustrates a LAN cable 71 that connects the storage apparatus 10, the switches 40, the operations management server 50, and the business server 60 with one another, FC cables 72 that connect the switches 40 with the business server 60, and FC cables 72 that connect the switches with the storage apparatus 10. The LAN cable 71 is a cable for control data communication, and the FC cables 72 are cables for communication of data to be written to the storage apparatus 10, data to be read out from the storage apparatus 10, and address for the write/read of data.

The operations management server 50 includes an acquiring unit 51 and determining unit 52. The acquiring unit 51 acquires information input on operation screen. The determining unit 52 determines a real storage which can be transferred from one storage pool to the other storage pool.

Although only one business server 60 is illustrated in FIG. 2 as a representative example, there is one business server (or two or more) on every storage pool (see FIG. 1) on a conceptual basis and the storage apparatus 10 can be accessed from a plurality of business servers 60.

As illustrated in FIG. 1, there are four real disks 21 to 24 in the storage apparatus 10. In addition, the storage apparatus 10 includes two control modules (CMs) 15, CM1 and CM2, which are responsible for control of access to the real disks. Furthermore, each CM is provided with two ports 16 (four ports in total).

A CM in charge of each of four real disks 21 to 24 in the storage apparatus 10 is previously determined to take charge of access to the real disks. Here, the CMs connected to the respective real disks 21 to 24 as illustrated in solid lines are the CMs in charge of these real disks. In contrast, the dashed lines represent that the CMs are not in charge. Specifically, the CMs in charge of the real disks 21 to 24 are CM0, CM1, CM0, and CM1 in order.

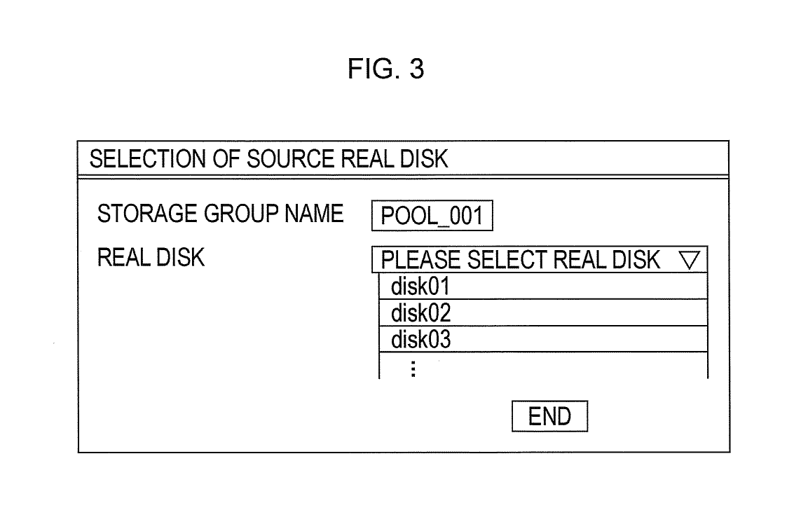

Furthermore, the operations management server 50 has charge of management of the storage apparatus 10 and so on. Specifically, the operations management server 50 manages the storage pools and the virtual disks which have been described with reference to FIG. 1. Information on these storage pools and virtual disks is transmitted to the switches 40 and used for carrying out the relay of data between the business server 60 and the storage apparatus 10 by the switches 40. Furthermore, the operations management server 50 also has charge of a process of logical removal and a process of searching a real disk to be transferred over storage pools, which will be described later with reference to FIG. 3 and the subsequent drawings.

Furthermore, there are two switches 40 illustrated in FIG. 2. Each of the business servers 60 (only one is illustrated as a representative example thereof in FIG. 2) is connected to both of two switches 40. In addition, each of these two switches 40 is connected to both of the port of the CM0 and the port of the CM1 among four ports on the storage apparatus 10.

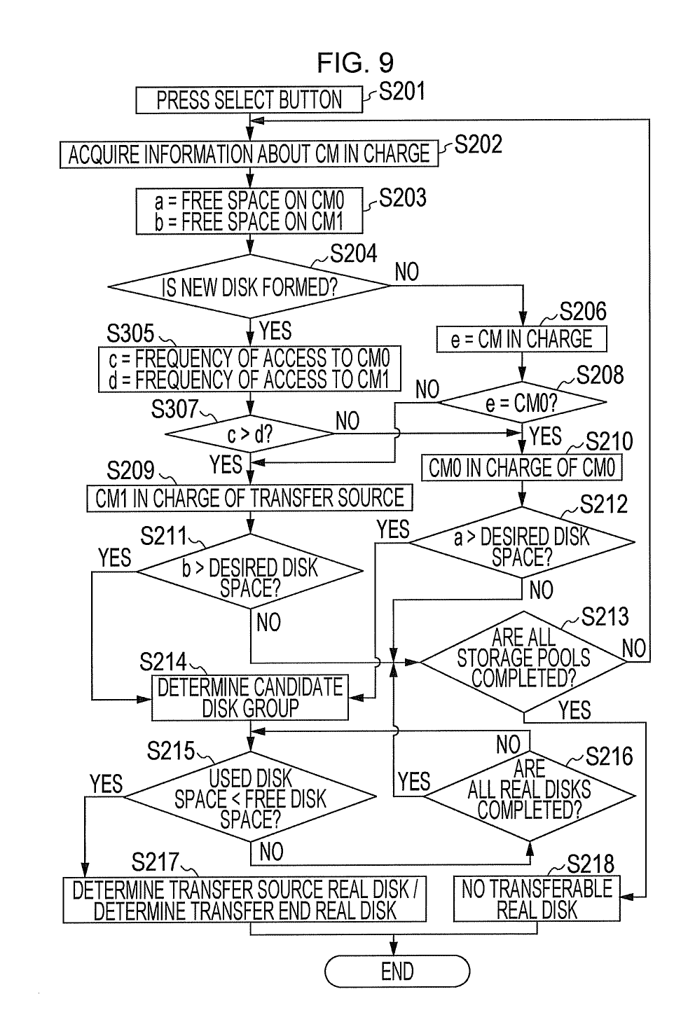

For example, when one business server 60 intends to access the storage apparatus 10 while another business server 60 is accessing the storage apparatus 10 via one of the switches 40 (e.g., switch 0), the other of the switches 40 (e.g., switch 1) which is an empty one has charge of the access of the former. These switches 40 retain the information about the CMs in charge of the respective real disks 21 to 24 and the information about the storage pools and the virtual disks notified from the operations management server 50 and employs the information to play a role in switching the flow of data between the business server 60 and the storage apparatus 10. Specifically, the switch 40 receives the request for access on the virtual disk from the business server 60 and changes the address on the virtual disk to the address on the real disk in the storage pool assigned to the user of the business server 60. Then, the CM in charge of the control of access to the real disk is allowed to control the access to the real disk. Subsequently, these switches 40 is also responsible for monitoring the frequency of access per each the CMs 15 in charge (in the case of an embodiment illustrated in FIG. 9) or transferring data between two real disks.

Next, various processes which can be performed by the operations management server 50 will be described.

First, an exemplified case of manual selection of a real disk to be logically taken (transferred) from the storage apparatus 10 by the operator of the operations management server 50 will be described.

FIG. 3 is a diagram illustrating a first example of an operation screen displayed on an operations management server 50.

On this screen, the name of a storage pool (for example POOL_001) from which a real disk is taken is input and the name of the real disk (for example disk 01 or disk02 or disk03 . . . ) be directed to be taken is then selected.

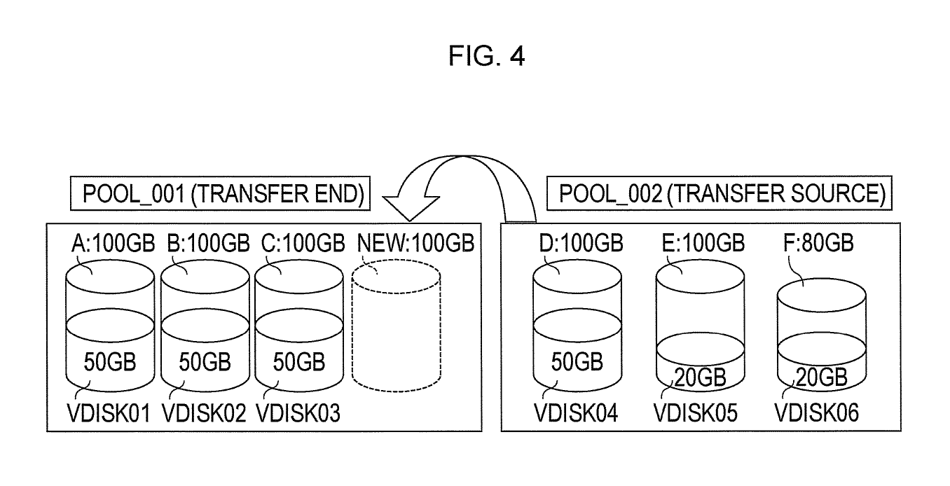

FIG. 4 is a diagram illustrating a first example of the storage pool.

Among six real disks A to F illustrated in FIG. 4, tree real disks A to C belong to a storage pool POOL_001 and other three real disks D to F belong to a storage pool POOL_002. Among these six real disks A to F, furthermore, each of five real disks A to E has a storage capacity of 100 GB and the remaining real disk F has a storage capacity of 80 GB. Virtual disks vdisk01, vdisk02, vdisk03, vdisk04, vdisk05, and vdisk06 are defined on their corresponding real disks A to F, respectively. Among these virtual disks vdisk01 to vdisk06, each of four virtual disks vdisk01 to vdisk04 has a storage capacity of 50 GB and each of the remaining two virtual disks vdisk05 and vdisk06 has a storage capacity of 20 GB. Furthermore, CMs in charge of six real disks A to F are CM1, CM1, CM0, CM0, CM1, and CM1 in order.

By way of example herein, it is assumed that the real disk E of the storage pool named POOL_002 is designated on the screen illustrated in FIG. 3.

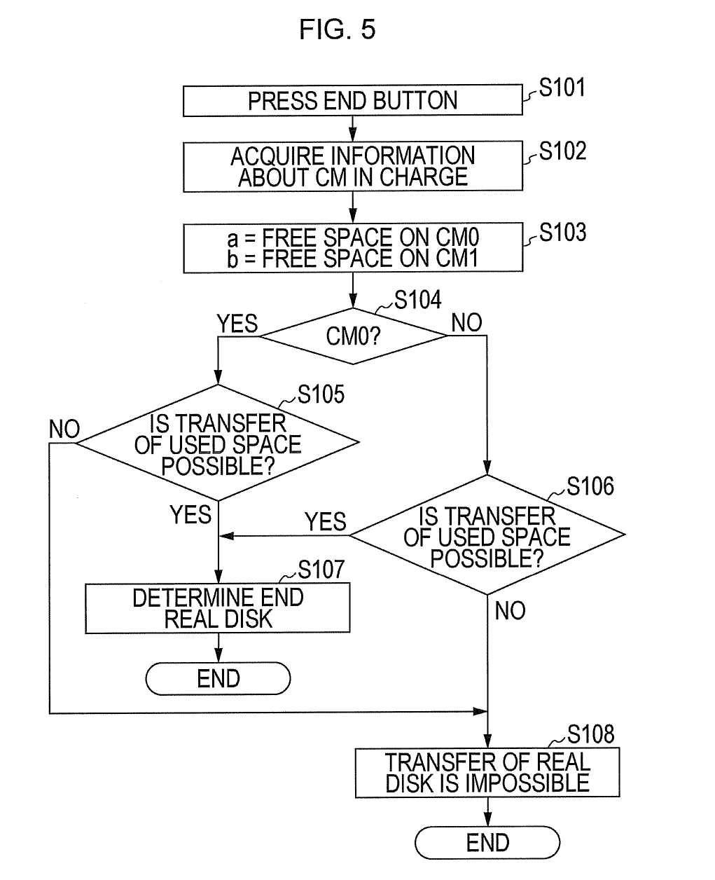

FIG. 5 is a flow chart illustrating a process to be carried out in the operations management server 40 when designated as described above.

In this flow chart, the process is carried out when an “end” button on the screen illustrated in FIG. 3.

If the depression of the “end” button is received (step S101), then the supply of information about the CMs in charge of the respective real disks D to F that constitute the designated storage pool (here, the storage pool POOL_002) is acquired (step S102). Next, the free space of each of the CMs (CM0,CM1) in charge of the respective read disks E to F in the designated storage pool POOL_002 is checked (step S103). Here, among three real disks D to F in the storage pool POOL_002, the real disk corresponding to the CM0 in charge is only the real disk D. Then, the free space (here, 50 GB) of the real disk D is calculated as the total empty space of the corresponding CM0 in charge (i.e., a=50 GB). In addition, among three real disks D to F in the storage pool POOL_002, the real disks corresponding to the CM1 in charge are two real disks E and F. Then, the total free space of two real disks E and F is calculated as the total empty space of the corresponding CM1 in charge (i.e., b=80 GB+60 GB=140 GB). Furthermore, it is determined whether the CM in charge of the real disk E is CM0 or CM1 (step S104). If the CM in charge is CM0, then the process proceeds to step S105. If the CM in charge is CM1, then the process proceeds to step S106. In the example illustrated herein, the CM in charge of the real disk E is the CM1. Thus, the process proceeds to step S106.

In step S106, the used space of the real disk E to be taken, or the storage capacity (20 GB) of the virtual disk vdisk05 built in the real disk E, is compared in size with the free space. Here, the target free space of the comparison is a free space obtained by subtracting the free space of the real disk E from the free space b for the CM1 in charge (the CM in charge of the real disk E). Thus, the target free space is “b−80 GB=60 GB”. Here, the used space (20 GB) is smaller than the free space (60 GB). Then transfer of the used space is possible. Thus, it is determined that the real disk E can be taken. Then, the process proceeds to step S107. Furthermore, if the CM in charge of the real disk designated as one to be taken is CM0, then step S105 performs the same processing as one performed in step S106, except for the replacement of CM1 by CM0, compared with step S106.

Step S107 determines a real disk to which the virtual disk vdisk05 built in the real disk E as a target to be taken will be transferred. The requirements for a real disk as a transfer end (i.e., the end real disk) are as follows: First, the real disk of interest belongs the same storage pool as that of the removal-target real disk E (i.e., the storage pool POOL_002) and the same CM as that of the removal-target real disk E has, charge of the real disk of interest (i.e., CM1). In addition, the real disk of interest a free space of not less than the used space of the virtual disk vdisk05 on the removal-target real disk E.

In the example illustrated in FIG. 4, the real disk that meets the requirements is the real disk G. Thus, the real disk G is designated as a real disk to which the virtual disk vdisk05 built in the real disk E will be transferred. Furthermore, the virtual disk vdisk05 may be divided and the divided portions thereof may be transferred to a plurality of real disks under the same CM in charge.

As described above, it is checked whether the removal-target real disk E can be taken and then determined that the real disk F is a real disk to which the virtual disk vdisk05 will be transferred. Subsequently, the operations management server 50 (see FIG. 2) directs the switch 40 to transfer the data stored in the virtual disk vdisk05 to the real disk F. Then, the switch 40 transfers the data stored in the virtual disk vdisk05 from the real storage E to the real disk F according to the instruction. When the operations management server 50 receives a notice of completion of the transfer from the switch 40, the real disk E is taken out of the storage pool POOL_002 and then transferred to the end storage pool POOL_001. This transfer is a logical work. Thus, it is only needed to change settings on each storage pool. The information about the new settings of the storage pools is transmitted to the switch 40. After that, the switch 40 will operate according to the new settings.

If it is concluded that the real disk E designated as a removal target in step S105 or step S106 illustrated in FIG. 5 cannot be taken, then the process proceeds to step S108 to notify the operator of the operations management server 50 that the designated real disk E cannot be taken. Transfer of the real disk E is impossible.

Although the flow chart illustrated in FIG. 5 is as above, the operator of the operations management server 50 may further install an additional virtual disk if required on the real disk E transferred to the storage pool POOL_001. Alternatively, the used space of the virtual disk (here, each of vdisk01 and vdisk02), which is built in any of the real disks (here, the real disks A and B) under the same CM as one in charge of the transferred actual disk (i.e., CM1), can be extended over the real disk E.

Next, the processing of automatically searching the transfer-target real disk in response to the designation of the transfer-end storage pool by the operator will be described.

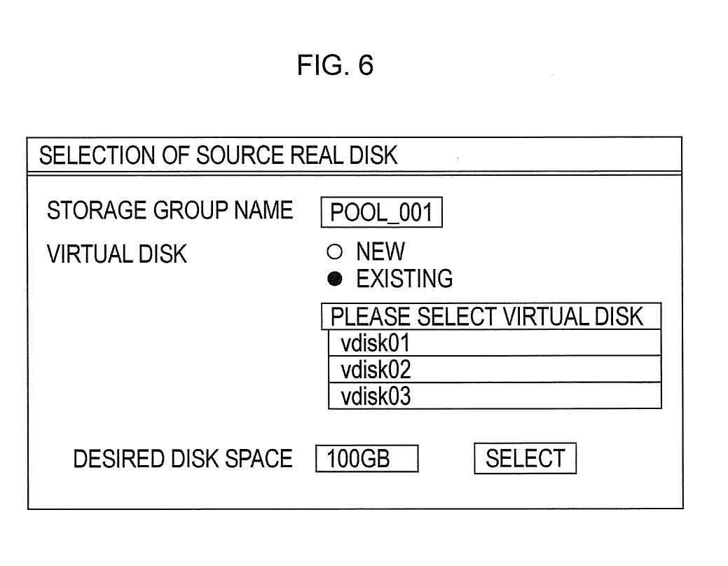

FIG. 6 is a diagram illustrating a second example of an operation screen displayed on an operations management server 50.

Here, both the case where the storage capacity of the existing virtual disk in the designated storage pool is added and the case where a new virtual disk is formed in the designated storage pool will be described.

In the case where the storage capacity of the existing virtual disk in the designated storage pool is added, an input of storage pool name, designation of “existing” of the virtual disk, designation of virtual disk name, and designation of desired space are performed on the screen illustrated in FIG. 6. Here, the storage pool name to be input is the name of the storage pool where the virtual disk to be provided with an additional storage capacity belongs. The virtual name designated here is the name of a virtual disk to be provided with an additional storage capacity. Furthermore, the desired space to be designated here is a desired additional storage capacity. These information is acquired.

On the other hand, in the case of forming a new virtual disk, an input of storage pool name, designation of a “new” virtual disk, and designation of desired space of the virtual disk to be newly formed are performed on the screen illustrated in FIG. 6. These information are acquired.

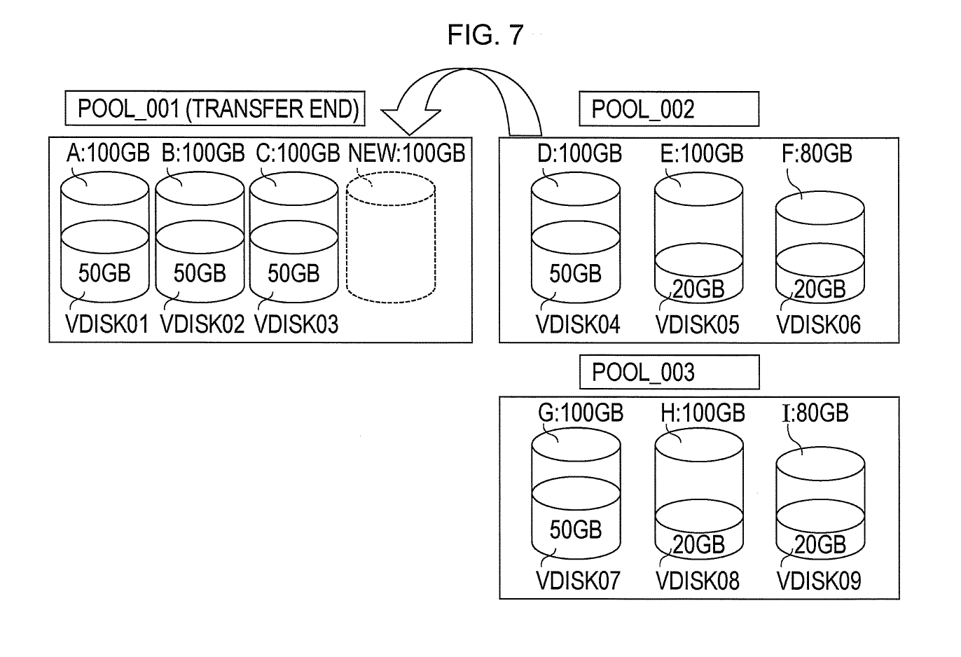

FIG. 7 is a diagram illustrating a second example of the storage pool.

Among nine real disks A to I illustrated in FIG. 7, three real disks A to C belong to the storage pool POOL_001. In addition, among the remaining real disks, three real disks D to F belong to the storage pool POOL_002. Furthermore, other three real disks G to I belong to the storage pool POOL_003. Furthermore, among these nine real disks A to I, the storage capacity of each of seven real disks A to E, G, and His 100 GB and the storage capacity of each of the remaining two real disks F and I is 80 GB. Virtual disks vdisk01 to vidisk09 are defined in the real disks A to I, respectively. Among these virtual disks vdisk01 to vdisk09, each of five virtual disks vdisk01 to vdisk04 and vdisk07 has a used space of 50 GB and each of the remaining four virtual disks vdisk05, vdisk06, vdisk08, and vdisk09 is 20 GB. Furthermore, the CMs in charge of these nine real disks A to I are CM1, CM1, CM0, CM0, CM1, CM0, CM1, CM1, and CM0 in order.

Now, two examples will be described. First, the case where the virtual disk vdisk02 defined in the real disk B of the storage pool POOL_001 is provided with an additional used space of 100 GB will be described.

In this case, designation of storage pool name “POOL_001”, designation of “existing” of the virtual disk, selection of virtual disk name “vdisk02”, and designation of desired space “100 GB” are performed on the screen illustrated in FIG. 6. These information is acquired.

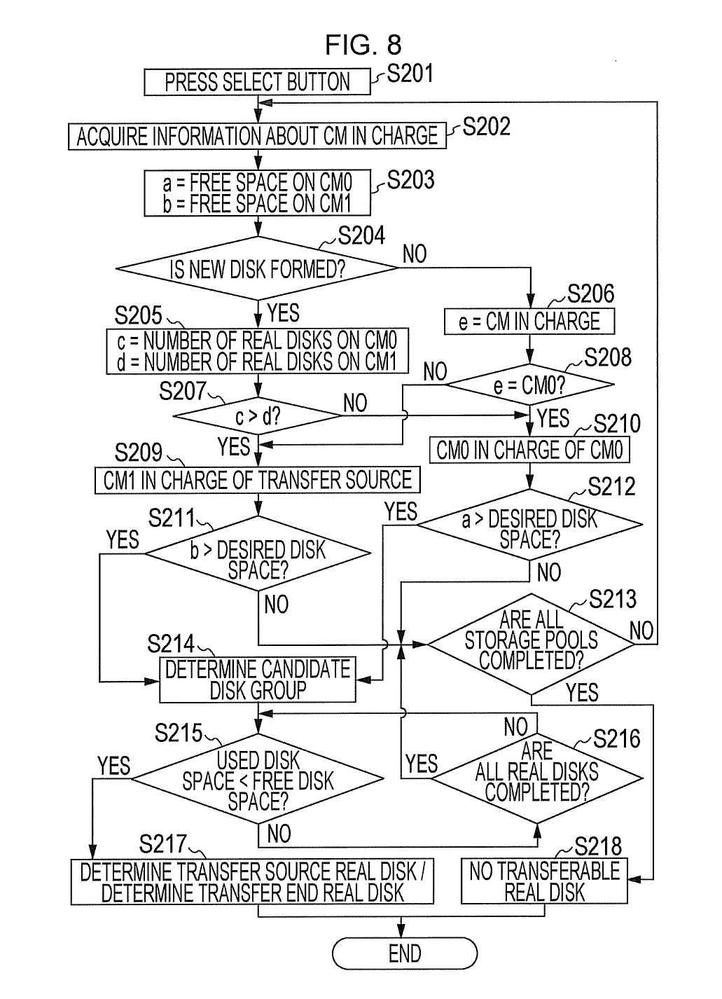

FIG. 8 is a flow chart illustrating a process to be carried out when a “selection” button is pressed on the screen illustrated in FIG. 6.

In this example, the following description will describe the case where one of the storage pools (here, the storage pool POOL_001) is designated and a real disk is transferred from another storage pool which is different from the designated storage. An extension or establishment of a virtual disk is performed on the transferred real disk.

In other words, the present embodiment is focused on the transfer of the real disk from one storage pool to another storage pool. Thus any description about the extension or establishment of a virtual disk using only the real disk in the storage pool without the transfer of the real disk will be omitted.

If the “selection” button is pressed on the screen illustrated in FIG. 6, and then the process illustrated in FIG. 8 is started (step S201). Here, storage pools (here, the storage pools POOL_002 and POOL_003) other than one designated on the screen (here, the storage pool POOL_001) are subjected to the following process in order. In other others, the process is firstly performed on the storage pool POOL_002.

In step S202, the management server 50 acquires information about CMs in charge of all real disks in the storage pool POOL_002 through the switches 40 illustrated in FIG. 2. Then, the real disks of the storage pool POOL_002 are grouped into those under CM0 in charge and those under CM1 in charge. Then, in step S203, the sum of the free spaces of the real disks in each of the groups is calculated. Here, the free space of the real disk under the CM0 in charge is referred to as “a” and the free space of the hard disk under the CM1 in charge is referred to as “b”. Specifically, among three real disks D to F in the storage pool POOL_002 illustrated in FIG. 7, the real disks that the CM0 is in charge of are two real disks D and F. The total free space “a” for the CM0 in charge is calculated as: a=50 GB+60 GB=110 GB. In addition, among three real disks D to F in the storage pool POOL_002, the real disks that the CM1 is in charge of are only one real disk E. The total free spaces “b” for the CM1 in charge can be calculated as: b=80 GB.

Next, in this instance, the process proceeds to step S204 and determines whether any existing virtual disk will be extended or a new virtual disk will be formed. Here, the extension of the existing virtual disk vdisk02 is intended to be performed. Thus, the process proceeds to step S206. In addition, two steps S205 and S207 are specific steps for establishment of a virtual disk. Thus, these steps will be described later.

In step S206, the management server 50 acquires information about CM in charge of the real disk (here, the real disk B) in which a virtual disk designated to be extended (here, the virtual disk vdisk02) is built through the switches 40 (see FIG. 2). Here, the CM in charge of such a real disk is referred to as “e”. Specifically, the CM in charge of the real disk B illustrated in FIG. 7 is CM1. In this instance, therefore, e=CM1.

Subsequently, in step S208, it is determined whether the CM in charge is CM0 or not. If e=CM1, then the process proceeds to step S209 and the CM in charge of the real disk in the transfer source is set to CM1. If e=CM0, then the process proceeds to step S210 and the CM in charge of the real disk in the transfer source is set to CM0. In the example described herein, the process proceeds to step S209 but not to step S210 because of e=CM1. The fact that the CM in charge of the hard disk in the transfer source is set to CM 1 means that, in the subsequent steps, a real disk that CM1 is in charge of will be searched as a real disk to be transferred to the storage pool POOL_001. Here, the process intends to extend the existing virtual disk vdisk02 built in the real disk B under the CM1 in charge. For this purpose, it is necessary to transfer the real disk under the same CM as one in charge of the real disk B (i.e., CM1) to the storage pool POOL_001.

Subsequently, in step S211, it is determined whether the total free space b for the CM1 in the storage pool POOL_002 (see step S203) is not less than the desired space defined in FIG. 6 (here, 100 GB). In the example described herein, the free space b for the CM1 in the storage pool POOL_002 is represented by b=80 GB. Thus, it is smaller than the desired space of 100 GB. Therefore, it is concluded “NO” in step S211. Then, the process proceeds to step S213.

Furthermore, when the process proceeds to steps S210 and S212, the same processing as that of steps S209 and S211 is performed with respect to the CM0.

If the process proceeds to step S213, then it is determined whether the search is completed in all the storage pools. Here, the term “all the storage pools” means storage pools (here, the storage pools POOL_002 and POOL_003) other than the storage pool (here, the storage pool POOL_001) designated on the screen illustrated in FIG. 6. At this stage, the process has completed the search in the storage pool POOL_002 but does not start the search in the storage pool POOL_003. Thus, the process returns to step S202 and then performs the search in the storage pool POOL_003 at this time.

Furthermore, if the process proceeds step S213 after performing the search in the storage pool (here, the storage pool POOL_003) as the last one of the searching process, it means that there is no real disk which can be transferred. In this cases, the process proceeds to step S218 to notify the operator of the operations management server 50 that there is no real disk which can be transferred.

Now, the description will be returned to step S202 to describe the process from starting the search in the storage pool POOL_003.

In Step S202, the management server 50 acquires information about CMs in charge of all real disks in the storage pool POOL_003 through the switches 40 illustrated in FIG. 2. In step S203, the real disks G to I of the storage pool POOL_003 are grouped into those under CM0 in charge and those under CM1 in charge, and the free spaces for the respective CMs in charge are calculated. Here, the free space “a” for the CM0 in charge is 60 GB (a=60 GB) which corresponds to the free space of one real disk 1. The free space “b” of the CM1 in charge corresponds to the sum of the free spaces of two real disks G and H (i.e., b=50 GB+80 GB=130 GB).

Next, the process proceeds to step S204 and then step S206. Here, it is found that the CM in charge of the real disk B is CM1 (e=CM1). Then the process proceeds to step S211 via steps S208 and S209. In this case, the free space “b” for the CM1 in the storage pool POOL_003 is b=130 GB, which is larger than the desired space of 100 GB. Thus, the process proceeds to step S214. In step S214, the group of real disks which serve as candidates to be transferred is determined. In this example, the real disk to be selected is one with a storage capacity of 100 GB or more located in the storage pool POOL_003 under the CM1 in charge. In this example, there are two candidate real disks G and H to be transferred.

Subsequently, the process proceeds to step S215. Then, the determination processing is carried out on all the transfer-candidate real disks (here, two real disks G and H) one by one until the real disk which can be transferred is found.

In this step S215, it is determined whether the total free space of the real disks under the CM1 in charge except for the free space of the real disk G (i.e., the total free space; b−50 GB (free space of the real disk G)=80 GB) is larger than the used space of the virtual disk vdisk07 (50 GB) built in the transfer-candidate real disk (here, the real disk G). In this example, the free space (80 GB) is larger than the used space (50 GB), then the process proceeds to step S217. Then, it is determined that the real disk G is one to be transferred to the storage pool POOL_001. The real disk G is transfer source real disk. In addition, the real disk H is determined as one to which the data of the virtual disk vdisk07 set in the real disk G (i.e., a transfer-end real disk).

Then, after determining both the transfer-source real disk G and the transfer-end real disk H for the transfer of the virtual disk vdisk07, the operations management server 50 (see FIG. 2) designates the switch 40 to transfer the virtual disk vdisk07 from the real storage G to the real disk H. Subsequently, the switch 40 responses the instruction and then transfers the data stored in the virtual disk vdisk07 from the real storage G to the real disk H. When the operations management server 50 receives a notice of completion of the transfer from the switch 40, the real disk G is taken out of the storage pool POOL_003 and then transferred to the end storage pool POOL_001. As described above, this transfer is a logical work. Thus, it is only needed to change settings on each storage pool. The information about the new settings of the storage pools is transmitted to the switch 40. After that, the switch 40 will operate according to the new settings.

If the used space of the virtual disk set in the transfer-candidate real disk is larger than the free space of the real disk to which the data of the virtual disk is transferred in step S215 illustrated in FIG. 8, then the process proceeds to step S216. Then, the same processing is repeated on the next transfer-candidate real disk. If any real disk which can be transferred is not found even though the same processing is repeatedly performed on all the transfer-candidate real disks, then the process proceeds to step S213. Then, the same processing is repeated on the next transfer-candidate real disk. If any real disk which can be transferred is not found even though the processing is repeated up to the last storage pool, then the process proceeds to step S218 and the operator is then notified of such a fact as described above.

Next, steps S205 and S207 illustrated in FIG. 8 will be described.

In this case, on the screen illustrated in FIG. 6, the storage pool name is set to “POOL_001”, the virtual disk is set to “new”, and the desired desk space is set to “100 GB”, followed by push of the “selection” button. These information is acquired.

The same steps other than steps S205 and S207 as those used in the case of the “existing” of the virtual disk are employed, so that duplicated descriptions thereof will omitted. Thus, only steps S205 and S207 will be described.

Step S205 determines the number of real disks where CM in charge thereof is CM0 and the number of real disks where CM in charge thereof is CM1 in all the real disks that constitute the storage pool to which a real disk will be transferred (here, the storage pool POOL_001). Here, the number of the real disks under the CM0 in charge is defined as “c” and the number of the real disks under the CM1 in charge is defined as “d”. Specifically, in the case of the example illustrated in FIG. 7, among the real disks A to C of the storage-pool POOL_001, there is only one real disk where CM in charge thereof is CM0, the real disk C. Thus, c=1. In addition, there are two real disks where CM in charge thereof is CM1, the real disks A and B. Thus, d=2.

In step S207, “c” and “d” defined as described above are compared. If c>d (i.e., the number of the real disks under the CM0 in charge is larger than the other), then the process proceeds to step S209 and the CM in charge of the transfer source is set to CM1. If c<d (i.e., i.e., the number of the real disks under the CM1 in charge is larger than the other), then the process proceeds to step S210 and the CM in charge of the transfer source is set to CM0.

This is a measure for equalizing the CMs in charge of the real disks in the storage pool POOL_001 after the transfer of real disk as much as possible. If the number of CM0 in charge and the number of CM1 in charge are disproportionate, then the process tends to be delayed. Thus, an increase in processing speed can be achieved by equalization. Here, the example illustrated in the figure is provided for establishment of the virtual disk. Thus, there is no need that the CM in charge of the transferred real disk is influenced by the existing virtual disk.

FIG. 9 is a flow chart illustrating a process to be carried out in an operations management server 50 in stead of the process illustrated by the flow chart illustrated in FIG. 8.

The flow chart illustrated in FIG. 9 is different from one illustrated in FIG. 8 in that steps S305 and S307 are employed in the flow chart of FIG. 9 in replacement of steps S205 and S207 in the flow chart of FIG. 8. Hereafter, this difference will be described.

In the case of a system in which the flow chart illustrated in FIG. 9 is carried out in the operations management server 50, the switches 40 (see FIG. 2) monitor the access frequencies of the respective real disks.

In step S305, the operations management server 50 acquires information about the access frequencies of all the real disks A to C in the storage pool (here, the storage pool POOL_001) to which a real disk will be transferred. Then, the access frequencies for the respective CMs in charge of these real disks in the storage pool are determined.

Here, the access frequency for CM0 is defined as “c” and the access frequency for CM1 is defined as “d”. In step S307, the size of “c” and the size of “d” are compared. If c>d, then it is found that the access frequency for CM0 is higher than one for CM1 and the process proceeds to step S208 to search a real disk to be transferred to the storage pool POOL_001 from the real storages where CM in charge thereof is CM1. On the other hand, if c<d, then it is found that the access frequency for CM1 is higher than one for CM0 and the process proceeds to step S210 to search a real disk to be transferred to the storage pool POOL_001 from the real storages where CM in charge thereof is CM0.

In this way, the switches 40 monitor the access frequencies of the respective real disks. In the case of forming a new virtual storage as illustrated in FIG. 9, it is preferable to acquire the information about the access frequencies of the real disks and determine CM in charge of a real disk to be transferred. In this case, the equalization of CMs in charge can be directly attained in comparison with the estimation of access frequencies from the numbers of the real disks under the control of the respective CMs in charge as illustrated in FIG. 8.

According to the present embodiment, a real storage which can be transferred from one storage pool to the other storage pool is searched. If there are real storages which can be transferred, then the real storage to be transferred is determined. Therefore, there is no need of unconsidered addition of a real storage. Thus, the storage capacity of a storage apparatus can be efficiently utilized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A management apparatus for managing a plurality of storage pools having a plurality of real storages grouped at each user and a virtual storage logically defined on the real storage in a storage apparatus, the storage apparatus having the plurality of the real storages existing physically and a plurality of controllers for individually controlling access to the respective real storages, the management apparatus comprising:
an acquiring unit for acquiring information of specifying a target virtual storage in a target storage pool and an expansion storage capacity to be acquired from another storage pool other than the target storage pool, and
a determining unit for determining the real storage to be used for the expansion storage capacity of the target virtual storage from candidate one of the real storages in the another storage pool, which are under the control of the controller in charge of the real storage that the target virtual storage is defined, on the basis of an occupied storage capacity defined as the virtual storage on the real storage in the another storage pool and a free storage capacity of the real storage in the another storage pool.

2. The management apparatus as described in claim 1, wherein, with respect to all of the candidate real storages in the another storage pool which have storage capacities not less than the expansion storage capacity, the determining unit makes a comparison between the occupied storage capacity defined as the virtual storage on one of the candidate real storages and total of the free storage capacity not defined as the virtual storage in all the candidate real storages other than the one of the candidate real storages, and determines the candidate real storage with the occupied storage capacity not more than the total of the free storage capacity as the real storage to be used for the expansion storage capacity of the target virtual storage.

3. A management apparatus for a plurality of storage pools having a plurality of real storages grouped at each user and a virtual storage logically defined on the real storage in a storage apparatus, the storage apparatus having the plurality of real storages for existing physically and a plurality of controllers for individually controlling access to the respective real storages, the management apparatus comprising:
an acquiring unit for acquiring information of specifying a target storage pool and a new storage capacity to be acquired from another storage pool other than the target storage pool, and
a determining unit for determining the real storage to be transferred to the target storage pool from candidate one of the real storages in the another storage pool, which are under the control of the controller having a comparatively low access frequency in control of access to the real storages belonging to the target storage pool, on the basis of an occupied storage capacity defined as the virtual storage on the real storage and a free storage capacity of the real storage in the another pool.

4. The management apparatus as described in claim 3, wherein, with respect to all of the candidate real storages in the another storage pool which have storage capacities not less than the expansion storage capacity, the determining unit makes a comparison between the occupied storage capacity defined as the virtual storage on one of the candidate real storages and total of the free storage capacity not defined as the virtual storage in all the candidate real storages other than the one of the candidate real storages, and determines the candidate real storage with the occupied storage capacity not more than the total of the free storage capacity as the real storage to be used for the expansion storage capacity of the target virtual storage.

5. The management apparatus as described in claim 3, wherein the access frequency is determined as the comparatively low access frequency when number of the real storage under the control of one of the controllers is smaller than that of the others.

6. A management apparatus for a plurality of storage pools having a plurality of real storages grouped at each user and a virtual storage logically defined on the real storage in a storage apparatus, the storage apparatus having the plurality of real storages for existing physically and a plurality of controllers for individually controlling access to the respective real storages, the management apparatus comprising:
an acquiring unit for acquiring information of specifying a candidate real storage to be logically taken out from the plurality of the real storages in the storage apparatus; and
a determining unit for making a comparison between the occupied storage capacity defined as the virtual storage on the candidate real storages and total of the free storage capacity not defined as the virtual storage in all the real storages, which are under the control of the controller in charge of control of access to the candidate real storage specified by the acquiring unit, in the storage pool belonging to the candidate real storage other than the candidate real storage, and for determining whether the candidate real storage can be logically taken out depending on whether the total of the empty storage capacities is not less than the occupied storage capacity.

7. The storage system comprising:
a storage apparatus having a plurality of real storages that exist physically and a plurality of controllers that individually control access to the respective real storages;
a conversion apparatus that converts an address on a virtual storage logically defined on the real storage into an address on the real storage in response to a request of access to the virtual storage from a user device and allows the controller to control the access to the real storage; and
a management apparatus for managing a plurality of storage pools where the plurality of real storages are grouped at each user and the virtual storage,
the management apparatus including:
an acquiring unit for acquiring information of specifying a target virtual storage in a target storage pool and an expansion storage capacity to be acquired from another storage pool other than the target storage pool, and
a determining unit for determining the real storage to be used for the expansion storage capacity of the target virtual storage from candidate one of the real storages in the another storage pool, which are under the control of the controller in charge of the real storage that the target virtual storage is defined, on the basis of an occupied storage capacity defined as the virtual storage on the real storage in the another storage pool and a free storage capacity of the real storage in the another storage pool.

8. The management apparatus as described in claim 7, wherein, with respect to all of the candidate real storages in the another storage pool which have storage capacities not less than the expansion storage capacity, the determining unit makes a comparison between the occupied storage capacity defined as the virtual storage on one of the candidate real storages and total of the free storage capacity not defined as the virtual storage in all the candidate real storages other than the one of the candidate real storages, and determines the candidate real storage with the occupied storage capacity not more than the total of the free storage capacity as the real storage to be used for the expansion storage capacity of the target virtual storage.
